(19) United States
(12) Patent Application Publication
(10) Pub. No.: US 2026/0348199 A1
(43) Pub. Date: Nov. 5, 2026

(54) DOUBLE-LOCKING SAFETY DEVICE FOR PROTECTING INFANTS

(71) Applicant: Jae Hwa KANG, Daegu (KR)

(72) Inventor: Jae Hwa KANG, Daegu (KR)

(21) Appl. No.: 19/486,932

(22) PCT Filed: May 9, 2024
(86) PCT No.: PCT/KR2024/006239

§ 371 Date: Nov. 23, 2025

(30) Foreign Application Priority Data
May 30, 2023 (KR) 10-2023-0069589

(51) Int. Cl. E05B 65/46; A47B 88/50; E05C 17/36

(52) U.S. Cl. CPC E05B 65/46; A47B 88/50; E05C 17/36

(57) ABSTRACT

A safety device for protecting infants (100) includes: a band (A) having a plurality of binding holes (a1) (a1′) formed thereon; and a pair of fixing members (B) which are fixed to furniture by bonding for locking or unlocking the band (A).

### TECHNICAL FIELD

The present invention relates to a safety device for protecting infants which is provided with a safety device that artificially controls opening or closing of a drawer or a hinged or sliding door of furniture, may quickly and easily open or close the door in a push button manner, and cannot be opened by young infants, and thus various safety-related accidents that often occur in infants due to the furniture or door inside a house may be prevented, and when the infants grow up and thus a user wants to remove the safety device attached to the furniture or door, the safety device may be removed very quickly, simply and neatly.

### BACKGROUND ART

As widely known, a cabinet used in a house is roughly classified as a drawer type, a sliding type, or a hinge type.

The drawer type is a method of pulling a drawer forward to open or pushing the drawer to close and is usually formed in two stages to a plurality of stages.

The sliding type is a laterally opening or closing method and usually refers to a component that is opened or closed while a door of furniture slides on a rail in a left-right direction.

The hinge type refers to a method of opening or closing a door through pushing while one side of the door is mounted on a door frame by a hinge.

However, surrounding environments and objects as well as the cabinet according to the related art having the above configuration are all curious to infants who crawl or are just starting to walk and thus are still not good at walking. Thus, when the infants try to stand up while the infants grip and pull the furniture and their weights are dependent on the furniture, in a process of opening or closing the drawer, the hinge door, and the sliding door, fingers or toes are caught and injured or the infants often fall and are injured. In severe cases, the furniture often falls and strikes the infants.

Meanwhile, various inventions including Korean Laid-Open Patent Publication No. 10-2015-0076563, Korean Laid-Open Patent Publication No. 10-2015-0089210, Korean Utility Model Registration No. 20-0428214, and Korean Utility Model Registration No. 20-0475948 are disclosed to solve the above problems.

However, in Korean Laid-Open Patent Publication No. 10-2015-0076563 and Korean Laid-Open Patent Publication No. 10-2015-0089210, it is designed to manufacture a safety device integral with the furniture by modifying an own structure of the furniture, and thus when a furniture manufacture does not apply these inventions in a furniture manufacturing process, these inventions cannot be used. In Korean Utility Model Registration No. 20-0428214 and Korean Utility Model Registration No. 20-0475948, the utility models may be mounted and used on the furniture in use, but a configuration is complicate, and an exterior is not neat after installation. Furthermore, in Korean Utility Model Registration No. 20-0428214, the utility model is inevitable to be easily separated from the furniture.

Meanwhile, to solve the problems of the inventions and the utility models, a safety device for protecting infants previously registered by the present inventor is registered as Korean Patent No. 10-1884589. This uses a method of locking or unlocking the safety device by rotating the safety device like a screw, which is a very simple locking and unlocking method and cannot be operated by forces of the infants, and thus safety is very excellent.

However, Korean Patent No. 10-1884589 uses a very safe method for young infants but is somewhat cumbersome and inconvenient to parents of the infants or users who protect or manage the infants because the safety device should be rotated when the drawer or the door is opened.

Further, in the previously registered patents and the previously registered utility models, the safety device is used while being fixedly attached to an object such as the drawer or the door using a double-sided adhesive tape, and as the infants grow up, the fixedly attached safety device should be removed. In this case, a fixing plate attached to a furniture surface is formed in a large area for a fixing force and safety, the double-sided adhesive tape having a strong adhesive force is attached to a bottom surface, it is very difficult to remove the fixing plate from the furniture surface, and thus when the fixing plate is removed, a lot of time is consumed, and a lot of effort is required. Furthermore, it is difficult to neatly remove the fixing plate, and thus the furniture or the door is often damaged.

### RELATED ART DOCUMENT

### Patent Documents

(Patent Document 1) 1. Korean Laid-Open Patent Publication No. 10-2015-0076563
(Patent Document 2) 2. Korean Laid-Open Patent Publication No. 10-2015-0089210
(Patent Document 3) 3. Korean Utility Model Registration No. 20-0428214
(Patent Document 4) 4. Korean Utility Model Registration No. 20-0475948
(Patent Document 5) 5. Korean Patent No. 10-188458

### DETAILED DESCRIPTION OF INVENTION

### Technical Problem

The present invention is invented to solve the above problems, and the present invention is directed to providing a safety device for protecting infants in which the safety device for protecting infants mounted and used in furniture or a door is operated in a push button manner, and thus a guardian may very quickly and easily lock or unlock the safety device, and the infants may never unlock the safety device.

Further, the present invention is also directed to providing a safety device for protecting infants that may be removed very quickly and easily when the infants grow up and thus a user wants to remove the safety device from the furniture.

### Technical Solution

A safety device (100) for protecting infants according to the present invention includes:
a band (A) formed of a soft resin, formed to have a predetermined length and width, and having binding holes (a1) at opposite ends thereof; and
a pair of locking parts (B) fixedly attached to furniture and a drawer or a door and a door frame to lock or unlock the band (A).

The band (A) further includes a plurality of binding holes (a1′) between the binding holes (a1) provided at the opposite ends thereof at regular intervals and thus may be selectively applied depending on a size of the furniture or a door, a boss (a2) protrudes to a predetermined height downward from lower portions of the binding holes (a1)(a1′), and an annular elastic part (a3) is formed on an inner circumferential surface of each of the binding holes (a1)(a1′).

The locking part (B) includes an attachment part (1) which includes a rotor binding part (b1) and a support part (b1′) and in which a double-sided adhesive tape (not illustrated) is attached to a bottom surface, a rotor (2) coupling the band (A) to the attachment part (1) together, and a pressing button (3) coupled to a head (2b) of the rotor (2) to lock or unlock the safety band (A).

Among the components of the attachment part (1), the rotor binding part (b1) includes a disk-shaped base (11) and a pair of elastic pieces (12) having a conical upper end at a center of an upper surface of the base and having catching steps (12′), the base (11) and the elastic pieces (12) being integrally formed.

A support part (b1′) includes a support tube (15) provided with a predetermined height and having a plurality of support protrusions (14) on an outer circumferential surface of an upper surface of a disk-shaped base (13) at regular intervals and a seating step (13′) which is formed at a lower end of a hole (15′) of the support tube (15), i.e., on a bottom surface of the base (13) and on which the base (11) of the rotor binding part (b1) is assembled and seated.

The rotor (2) includes the head (2b) and an insertion tube (2b′), and the head (2b) has fitting grooves (21) vertically formed on opposite sides of an inner wall thereof and has guide holes (22) formed through front and rear surfaces thereof and each including a button fixing groove (22b) and a button elevating groove (22b′). Further, as opposite sides of the fitting grooves (11) are formed as inclined surfaces (21′), and guide parts (23) are also formed at lower portions of the fitting grooves (21) toward the guide holes (22), when the guide protrusions (31) of a pressing plate (3c) are assembled to the guide holes (22), first, when the pressing plate (3c) rotates clockwise or counterclockwise in a state in which the guide protrusions (31) are inserted into the fitting grooves (21), elastic parts (32) integrally formed with the guide protrusions (31) are pushed toward elastic guide holes (33) and are restored when reaching the guide holes (22), thus the guide protrusions (31) are naturally assembled to the guide holes (22).

Further, the insertion tube (2b′) has a male screw protrusion (25) at a predetermined position of an outer circumferential surface thereof and has an annular catching step (24) formed inward from a lower end thereof, when the insertion tube (2b′) is inserted into the elastic piece (12) through the hole (15′) of the support part (b1′), a lower end of the insertion tube (2b′) is inserted while the elastic piece (12) is closed, and after the insertion, the closed elastic piece (12) is restored, the catching step (24) is caught by the catching step (12′), and thus the safety device rotates but is not separated.

Further, the pressing button (3) includes the pressing plate (3c) and an unlocking tube (3c′), and the pressing plate (3c) has elastic parts (32) having a disk shape and having the guide protrusions (31) at front and rear portions thereof and has elastic guide holes (33) that guide the guide protrusions (31) such that the guide protrusions (31) are stably assembled to the guide holes (22), and elastic pieces (34) acting as springs are formed on opposite sides of a bottom surface of the pressing plate (3c).

The unlocking tube (3c′) is vertically formed to a predetermined length and has an inclined surface (35) having a shape of which an upper portion is narrow and a lower portion is wide so that, when the releasing plate (3c′) is pushed, the elastic piece (12) is closed.

### ADVANTAGEOUS EFFECTS

According to the present invention, a plurality of binding holes (a1)(a1′) are provided in a band (A) at predetermined intervals, and thus the binding hole at an appropriate position can be selectively used depending on a structure, a shape, or a size of furniture, a door, or the like.

Further, when the band (A) is separated to unlock a safety device (100), in a state in which a head (2b) of a rotor (2) is gripped with one hand, only when a pressing button (3) is slightly turned with the other one hand, a guide protrusion (31) present in a button fixing hole (22b) is positioned to a button elevating groove (22b′), and a pressing plate (3c) is then pushed, the safety device (100) may be unlocked. Thus, in a locked state, even when young infants grip and turn or push a locking part (B), the locking part (B) is not pushed while idling, and thus safety is very excellent.

Further, according to the present invention, when a user wants to remove the safety device from attached furniture or the like as infants grow up, the safety device is primarily unlocked, the band (A) is separated from the rotor (2), and then only the rotor (2) is fastened to a female screw part (16) of an attachment part (1) again. In this case, in a state in which the band (A) is interposed, a male screw protrusion (23) cannot be fastened to a female screw part (16), but when the male screw protrusion (23) is fastened to the female screw part (16) after the band (A) is removed, as the male screw protrusion (23) is fastened to the female screw part (16), a support part (b1′) fixedly attached to furniture or a drawer or a door or a door frame is naturally and forcibly removed and separated, and thus the safety device may be removed easily. Accordingly, post-disassembling and processing are performed very easily, and thus safety and reliability are maximized.

### DESCRIPTION OF DRAWINGS

FIGS. 1 to 6 illustrate an embodiment of the present invention.

FIG. 1 is an exploded perspective view of a portion of a safety device for infants.

FIG. 2 is an exploded front view of a portion of the safety device for infants.

FIG. 3 is a cross-sectional view illustrating an assembling state.

FIG. 4 is an enlarged exploded perspective view of a rotor and a pressing plate.

FIG. 5 is a front view illustrating the assembling state.

FIG. 6 is a plan view of the safety device illustrating the assembling state.

FIG. 7 is an enlarged cross-sectional view of a locking part.

FIG. 8 is an enlarged cross-sectional view of a main portion of a locking part illustrating a state in which a support part is separated from an attachment surface.

### MODES OF THE INVENTION

The present invention is intended to prevent a safety-related accident that often occurs in infants in relation to furniture. In particular, a safety device operates in a push button manner and thus may be locked or unlocked very quickly and easily. Further, once the safety device is locked, even when young infants catch and rotate a locking part B due to curiosity or randomly push the locking part B, the safety device is not unlocked, and thus safety is very excellent.

Further, a safety device for protecting infants, in which, even when a safety device 100 fixedly attached to the furniture is separated and removed as the infants grow up, a double-sided adhesive type as well as an attachment part 1 may be quickly and easily removed, and thus safety and reliability may be maximized, may be provided.

Hereinafter, the present invention will be described in detail with reference to the accompanying drawings.

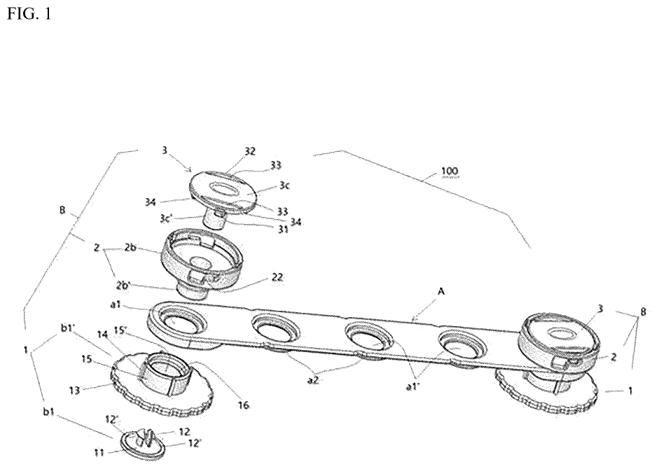

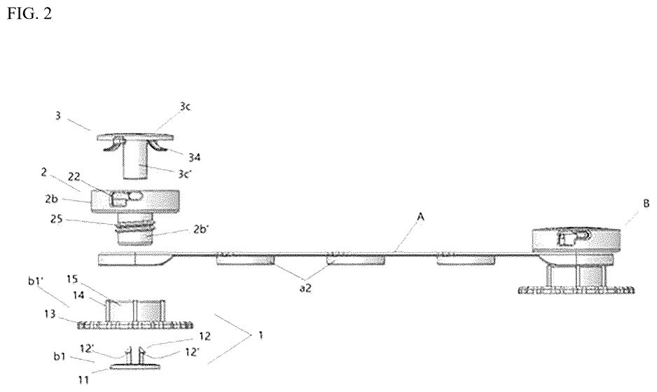

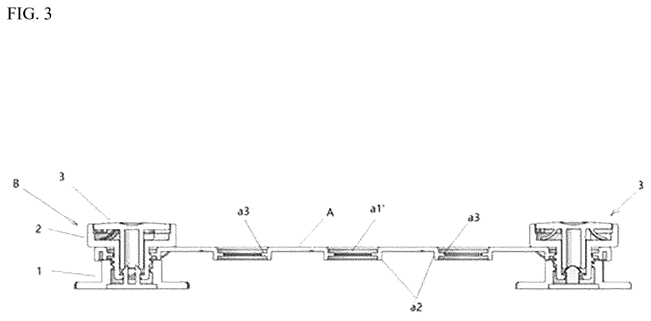

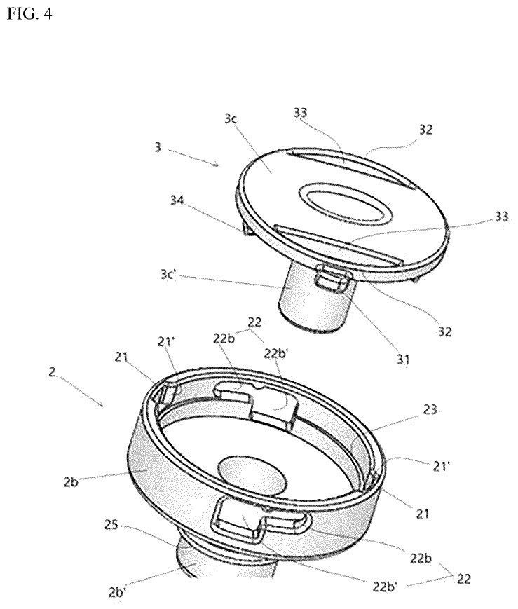

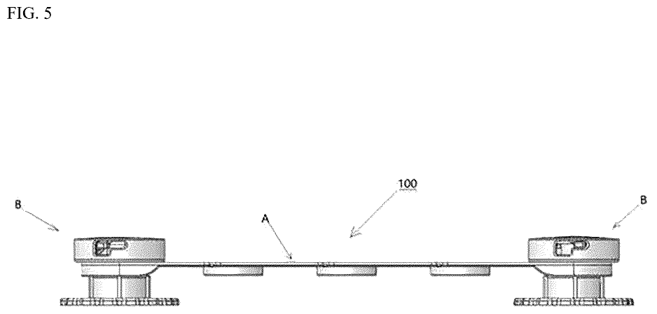

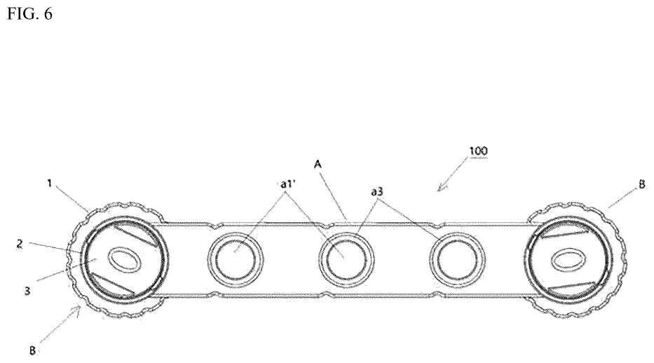

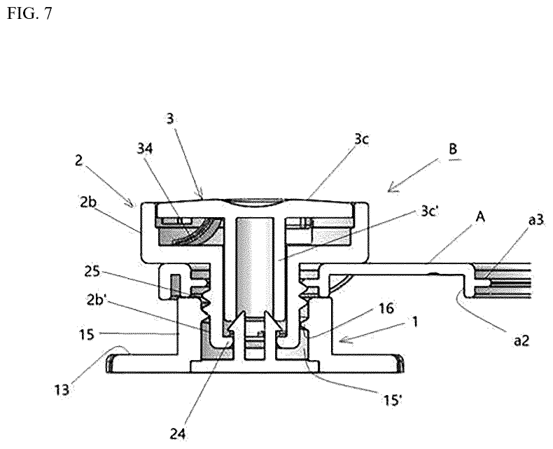

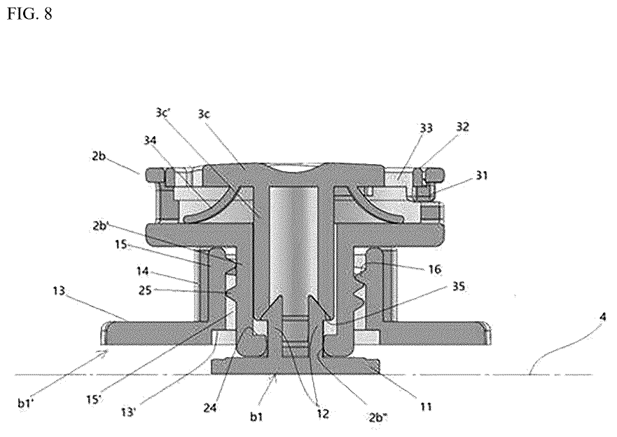

In FIGS. 1 to 8, FIG. 1 is an exploded perspective view of a portion of a safety device for infants, FIG. 2 is an exploded front view of a portion of the safety device for infants, FIG. 3 is a cross-sectional view illustrating an assembling state, FIG. 4 is an enlarged exploded perspective view of a rotor and a pressing plate, FIG. 5 is a front view illustrating the assembling state, FIG. 6 is a plan view of the safety device illustrating the assembling state, FIG. 7 is an enlarged cross-sectional view of a locking part, and FIG. 8 is an enlarged cross-sectional view of a main portion of a locking part illustrating a state in which a support part is separated from an attachment surface.

As illustrated in FIGS. 1 to 8, a safety device 100 for protecting infants according to the present invention includes a band A having a plurality of binding holes and a pair of locking parts B.

The band A is made of a flexible soft resin and formed in a predetermined width and length and has a plurality of binding holes a1 and a1′ formed at regular intervals, each of the binding holes a1 and a1′ has a boss a2 protruding to a predetermined height from a bottom surface thereof, and an annular elastic part a3 is formed on an inner circumferential surface of the binding holes a1 and a1′.

The annular elastic part a3 has a small thickness which allows a male screw protrusion 23 having a greater diameter than an inner diameter of the annular elastic part a3 to smoothly pass therethrough when an insertion tube 2b′ provided at a lower portion of a rotor 2 is inserted. After the male screw protrusion 23 passes through the annular elastic part a3, a state in which the rotor 2 is coupled to the binding hole a1 or the binding hole a1′ is maintained, and thus there is no concern that the safety device 100 is lost when the safety device 100 is unlocked or is maintained in an unlocked state.

Further, since the plurality of binding holes a1 and a1′ are formed in the band A, a binding hole at an appropriate position may be selectively applied depending on a size, a shape, and a form of the furniture. Accordingly, the safety device 100 may be applied to the furniture having various sizes and various shapes, thereby further improving reliability according to usage.

The locking part B includes the attachment part 1 including a rotor binding part b1 and a support part b1′, the rotor 2 assembled through the binding hole a1 and a hole 15′ of the support tube 15 after the band A is placed at an upper end of the attachment part 1 such that the binding hole a1 and the hole 15′ of the support tube 15 coincide with each other, and a pressing button 3 that is assembled to a head 2b of the rotor 2 and serves as a key.

The attachment part 1 includes the rotor binding part b1 and the support part b1′. In a state in which a base 11 of the rotor binding part b1 is coupled to a seating step 13′ on a bottom surface of a central portion of the support part b1′, a double-sided adhesive tape is attached to a bottom surface of the base 13 and 11, and thus the rotor binding part b1 and the support part b1′ are integrally formed by the double-sided adhesive tape.

Further, the rotor 2 includes the head 2b and the insertion tube 2b′. The head 2b is a portion in which the pressing button 3 is inserted and installed, has fitting grooves 21 vertically formed on opposite surfaces of an inner wall thereof, has stepped guide holes 22 formed through front and rear surfaces thereof and each including a button fixing groove 22b and a button elevating groove 22b′, has inclined surfaces 21′ formed on opposite sides of the fitting grooves 21, and has guide parts 23 formed at lower ends of the fitting grooves 21 and passing through the guide holes 22. Guide protrusions 31 are integrally formed with elastic parts 32, in which elastic guide holes 33 are provided, in a pressing plate 3c, and thus when the pressing plate 3c is assembled to the head 2b, when the guide protrusions 31 of the pressing plate 3c are fitted through the fitting grooves 21 and then the pressing plate 3c is rotated, the guide protrusions 31 may be assembled to the guide holes 22 due to organic actions of the inclined surfaces 21′ and the guide parts 23 and the elastic parts 32 and the elastic guide holes 33. Therefore, the rotor 2 and the pressing button 3 may be stably assembled.

The insertion tube 2b′ formed at a lower portion of the head 2b has a male screw protrusion 25 protruding from a predetermined position of an outer circumferential surface and has an annular catching step 24 formed in an inner circumferential surface of a lower end thereof. Thus, when the insertion tube 2b′ is pressed in a state in which a lower end of the insertion tube 2b′ is seated on an upper end of an elastic piece 12 while the insertion tube 2b is inserted into the hole 15′ of the support part b1′, a lower hole 2b“ of the insertion tube 2b′ is inserted while forcibly closing an upper portion of the elastic piece 12, the elastic piece 12 returns to an original state thereof as soon as the lower hole 2b” is completely inserted, and thus the catching step 24 is caught and supported by a catching step 12′ of the elastic piece 12. Therefore, a stable assembling state is maintained always, and at the same time, a rotatable state is achieved.

Further, the pressing button 3 assembled to the head 2b includes the pressing plate 3c and an unlocking tube 3c′. The pressing plate 3c includes the elastic parts 32 formed in a disk shape and having the guide protrusions 31 provided at front and rear sides thereof and elastic guide holes 33 that help operations of the guide protrusions 31 and the elastic parts 32 to stably assemble the pressing button 3 to the guide holes 22 of the head 2b.

Thus, as described above, when the guide protrusions 31 of the pressing plate 3c is turned after inserted through the fitting grooves 21 formed opposite to an inner circumferential portion of the head 2b, as soon as the guide protrusions 31 are naturally pushed back by an organic action of the elastic parts 32 and the elastic guide holes 33 and reach the passing guide holes 22, the guide protrusions 31 are inserted into the guide holes 22 by a restoring force of the elastic parts 32, and thus the rotor 2 and the pressing button 3 are assembled. After the assembling, the pressing plate 3c is operated so that the guide protrusions 31 are positioned in the button fixing grooves 22b or the button elevating grooves 22b′, and thus the safety device 100 may be locked or unlocked.

Meanwhile, in a state in which the guide protrusions 31 are positioned in the button elevating grooves 22b′, when the pressing plate 3c is pushed, the unlocking tube 3c′ may be lowered and perform unlocking. However, when the guide protrusions 31 are positioned in the button fixing grooves 22b, the pressing plate 3c is not pushed even when a user pushes the pressing plate 3c, and elastic pieces 34 acting as springs are formed on opposite sides of a bottom surface of the pressing plate 3c. Thus, the pressing plate 3c may be always stably restored.

Thus, in a state in which the pressing plate 3c is turned and the guide protrusions 31 are positioned in the button fixing holes 22b, the pressing plate 3c is not pushed even when the user presses the pressing plate 3c, and thus the safety device 100 cannot be unlocked. Only when the pressing plate 3c is turned in a direction opposite to the above direction and the guide protrusions 31 are positioned in the button elevating grooves 22b′, when the pressing plate 3c is pressed, the unlocking tube 3c′ is lowered, an inclined surface 35 at a lower end of the unlocking tube 3c′ closes the elastic piece 12, and thus the rotor 2 may be unlocked after separated from the attachment part 1.

When the safety device 100 for protecting infants according to the present invention as formed in this way is mounted and used, first, the attachment part 1 is fixedly attached to a body and a drawer of the furniture at a predetermined position, and in this case, is fixedly attached in consideration of the binding holes a1 and a1′ provided in the band A.

Next, the insertion groove 2b′ of the rotor 2 in which the pressing button 3 is assembled. In this case, the soft annular elastic part a3 provided in the inner circumferential surface of the binding hole allows the male screw protrusion 25 to be smoothly inserted, and at the same time, the male screw protrusion 25 is never separated unless the male screw protrusion 25 is intentionally separated after the insertion. Thus, a state in which the band A and the rotor 2 are always assembled may be maintained.

Next, in a state in which the guide protrusions 31 of the pressing button 3 are adjusted to be positioned in the button fixing holes 22b, the insertion tube 2b′ of the rotor 2 connected and assembled to the band A is inserted into the hole 15′ of the support tube 15. In this case, since the catching step 24 at the lower end of the insertion tube 2b′ is caught by the catching step 12′ of the elastic piece 12 provided in the rotor binding part b1, when the rotor 2 is gripped and rotated, the rotation is performed, but when the rotor 2 is pulled, the rotor 2 is not separated.

Thus, in this state, even when the infants grip and turn the locking part B or grip and pull the locking part B, the rotor 2 rotates but is never separated, and thus the infants can be safely protected.

Further, when a guardian wants to unlock the safety device 100 as needed in a process of use, when the head 2b of the rotor 2 is gripped with one hand and the pressing plate 3c is slightly turned counterclockwise with the other one hand, the guide protrusions 31 positioned in the button fixing holes 22b move to the button elevating grooves 22b′. In this state, when the user presses the pressing button 3, the pressing button 3 may be lowered, the inclined surface 35 at the lower end of the unlocking tube 3c′ may close the elastic piece 12, and thus the insertion tube 2b′ may be separated. Since the rotor 2 is gripped and removed while the pressing button 3 is pressed, the safety device 100 may be very quickly unlocked.

In the present invention, a female screw part 16 in an inner circumferential surface of the support tube 15 of the support part b1′ and the male screw protrusion 25 on an outer circumferential surface of the insertion tube 2b′ of the rotor 2 are formed so as not to be fastened to each other when the boss a2 of the band A is seated on an upper end of the support tube 15. Thus, when the safety device 100 is locked, the safety device 100 is freely rotated but is not unlocked, thereby achieving excellent safety.

However, in the insertion tube 2b′ from which the band A is separated, the male screw protrusion 25 may be fastened to the female screw part 16 provided in the inner circumferential surface of the support tube 15, and thus the support part bl′ attached to the furniture in the fastening process may be easily removed.

Thus, when it is determined that the safety device 100 is no longer required as the infants grow up, the band A assembled and connected to the insertion tube 2b′ is separated first in the unlocked state, and then the male screw protrusion 23 of the insertion tube 2b′ is fastened to the female screw part 16 in the inner circumferential surface of the support tube 15 of the attachment part 1. In this case, in a process of fastening the male screw protrusion 23 to the female screw part 16, the support part b′ is forcibly lifted up with respect to the rotor binding part b1.

Next, when the pressing plate 3c is pressed, the elastic piece 12 is closed, and thus the rotor 2 is separated from the elastic piece 12. In this case, the remaining rotor binding part b1 may have a small size and may be in a protrusion state, an adhesive area may be small, and thus the rotor binding part b1 may be easily pushed and removed with a hand or a hand part.

Thus, the double-sided adhesive tape attached to the bottom surface of the support part b1′ may be easily separated from a furniture surface or the bottom surface of the base 13, and the rotor binding part b1 may be easily removed. In this process, when a tape residue is present on the furniture surface, the tape residue may be quickly and neatly removed using a removal material.

As described above, according to the present invention, the safety device may be locked or unlocked in a push button manner and thus may be very conveniently handled and used and very safe. Further, when the user wants to remove the safety device 100 from the furniture after the use, the safety device 100 may be removed very quickly, simply and neatly. The scope of right is not limited to the above embodiments, thus various modifications may be implemented within the scope of the purpose and spirit of the invention, and these modifications may be naturally included in the scope of right of the present invention.

1. A double-locking safety device that is a double-locking safety device (100) for protecting infants, comprising a band (A) formed of a soft resin, formed to have a predetermined length and width, and having binding holes (a1) at opposite ends thereof and a pair of locking parts (B) fixedly attached to furniture and a drawer or a door and a door frame,
wherein the band (A) further includes a boss (a2) protruding to a predetermined height downward from a lower portion of the binding hole (a1) and an annular elastic part (a3) formed with a small thickness such that a male screw protrusion (25) of a rotor (2), which is described below, is easily inserted into an inner circumferential surface of the binding hole (a1), and at the same time, is not easily separated unless the male screw protrusion (25) is artificially separated after inserted, and thus loss of the rotor (2) is prevented, and
the locking part (B) includes:
an attachment part (1) which includes a rotor binding part (b1) in which a pair of elastic pieces (12) having catching steps (12′) are provided and a support part (b1′) having a support tube (15) having a support protrusion (14) and having a predetermined height and in which a double-sided adhesive tape (not illustrated) is attached to a bottom surface of the rotor binding part (b1) and a bottom surface of the support part (b1′);
the rotor (2) in which a boss (a2) of the band (A) is seated at an upper end of the support tube (15) of the attachment part (1) such that the binding hole (a1) of the band (A) and a hole (15′) of the support tube (15) coincide with each other and which passes through the binding hole (a1) and the hole (15′) of the support tube (15), fixedly couples an insertion tube (2b′) to the catching step (12′) of the elastic piece (12), and thus prevents disassembling while freely rotating; and
a pressing button (3) in which guide protrusions (31) are inserted through fitting grooves (21) vertically formed on opposite sides of an inner wall of a head (2b) of the rotor (2) and are then rotated, and the guide protrusions (31) are assembled to guide holes (22) each including a button fixing groove (22b) and a button elevating groove (22b′) and which is safe because the rotor (2) only idles and is not disassembled even when the rotor (2) is gripped and turned when the guide protrusions (31) are positioned in the button fixing grooves (22b) and separates the rotor (2) as an unlocking tube (3c′) is lowered to close the elastic piece (12) when the guide protrusions (31) are positioned in the button elevating grooves (22b′), and at the same time, are pressed.

2. The double-locking safety device of claim 1, wherein a plurality of binding holes (a1′) are further formed between the binding holes (a1) at the opposite ends at regular intervals and are selectively applied depending on a size of the furniture or the door.

3. The double-locking safety device of claim 1, wherein the attachment part (1) includes:
a rotor binding part (b1) including a pair of elastic pieces (12) having a conical upper end at a center of a disk-shaped base (11) and also having catching steps (12′); and
a support part (b1′) having a support tube (15) provided with a predetermined height and having a plurality of support protrusions (14) on an outer circumferential surface of an upper surface of a disk-shaped base (13) at regular intervals and having a seating step (13′) in which the base (11) of the rotor binding part (b1) is assembled and seated at a lower end of the hole (15′) of the support tube (15), i.e., on a bottom surface of the base (13).

4. The double-locking safety device of claim 1, wherein the rotor (2) includes the head (2b) and the insertion tube (2b′), the head (2b) has the fitting grooves (21) vertically formed on opposite sides of an inner wall thereof and has guide holes (22) formed through front and rear surfaces thereof and each including a button fixing groove (22b) and a button elevating groove (22b′), as opposite sides of the fitting grooves (11) are formed as inclined surfaces (21′), and guide parts (23) are also formed at lower portions of the fitting grooves (21) toward the guide holes (22), when the guide protrusions (31) of a pressing plate (3c) are assembled to the guide holes (22), first, when the pressing plate (3c) rotates clockwise or counterclockwise in a state in which the guide protrusions (31) are inserted into the fitting grooves (21), elastic parts (32) integrally formed with the guide protrusions (31) are forcibly pushed toward elastic guide holes (33) and are restored when reaching the guide holes (22), thus the guide protrusions (31) are assembled to the guide holes (22), and after the assembling, the safety device is not disassembled unless the pair of guide protrusions (31) are simultaneously pressed in an inward direction from an outside, and
the insertion tube (2b′) has the male screw protrusion (25) at a predetermined position of an outer circumferential surface thereof and has an annular catching step (24) formed inward from a lower end thereof, and when the insertion tube (2b′) is inserted into the pair of elastic pieces (12) through the hole (15′) of the support part (b1′), the catching step (24) is caught by the catching step (12′) of the elastic piece (12), and thus the safety device rotates without disassembling.

5. The double-locking safety device of claim 1, wherein the pressing button (3) includes a pressing plate (3c) and the unlocking tube (3c′), the pressing plate (3c) has elastic parts (32) having a disk shape and having the guide protrusions (31) at front and rear portions thereof and has elastic guide holes (33) that guide the guide protrusions (31) such that the guide protrusions (31) are stably assembled to the guide holes (22), and elastic pieces (34) acting as springs are formed on opposite sides of a bottom surface of the pressing plate (3c), and
the unlocking tube (3c′) is vertically formed to a predetermined length and has an inclined surface (35) having a shape of which an upper portion is narrow and a lower portion is wide so that, when the pressing plate (3c) is pushed, the elastic piece (12) of the rotor binding part (b1) on an inner side of a lower end thereof is closed.

6. The double-locking safety device of claim 1, wherein a female screw part (16) in an inner circumferential surface of the support tube (15) of the support part (b1′) and the male screw protrusion (25) on an outer circumferential surface of the insertion tube (2b′) of the rotor (2) are formed so as not to be fastened to each other when the boss (a2) of the band (A) is seated on an upper end of the support tube (15), and thus when the safety device (100) is locked, the safety device 100 is freely rotated but is not unlocked, and when a user wants to remove the safety device (100) from the furniture after infants grow up, the male screw protrusion (25) of the insertion tube (2b′) is fastened to the female screw part (16) in the inner circumferential surface of the support tube (15) only when the band (A) is separated from the insertion tube (2b′), and thus the support part (b1′) firmly attached to the furniture is quickly and easily removed.
